(19) United States
(12) Patent Application Publication
(10) Pub. No.: US 2011/0231241 A1
(43) Pub. Date: Sep. 22, 2011

(54) REAL-TIME PERSONALIZATION OF SPONSORED SEARCH BASED ON PREDICTED CLICK PROPENSITY

(75) Inventors: Anandsudhakar Kesari, Santa Clara, CA (US); Stefan Schroedl, San Francisco, CA (US); Leonardo Neumeyer, Palo Alto, CA (US)

(73) Assignee: Yahoo! Inc., Sunnyvale, CA (US)

(21) Appl. No.: 12/727,068

(22) Filed: Mar. 18, 2010

(51) Int. Cl. G06Q 30/00; G06F 17/30

(52) U.S. Cl. 705/14.42; 707/769; 707/E17.014

(57) ABSTRACT

Embodiments are directed towards employing long and short term historical user click propensity behaviors to adapt or filter a number of advertisements displayed and their location on a search results' page. A network device tracks a user's short and long term historical click behaviors. For a given search query for the user, a variety of candidate advertisements are selected. A normalized click-through rate (COEC) is estimated for each advertisement. The COEC and the user's short and long term click behavior, represented by User Click Propensity (UCP), is used to generate a User effective Cost Per Thousand (UeCPM) value. Candidate advertisements are filtered based on a minimum threshold value for UeCPMs. Page placement for the remaining advertisements is determined based on a user expected revenue for an advertisement determined from the UCP. Advertisements having a user expected revenue above another threshold are placed in a north page location.

### TECHNICAL FIELD

Embodiments relate generally to advertisement placement, and, more particularly, but not exclusively to, employing long and/or short term historical user click propensity behaviors to infer the user's relative advertisement preferences, and based on such inference adapt for the given user a number of advertisements displayed and their location on a search results' page.

### BACKGROUND

Commercial search engines typically provide web search result links, called organic results, along with advertisements in response to a user's search query. Well-targeted advertisements can be quite useful to a shopper. However, there may also be a risk that less relevant advertisements can affect a user's search experience. Over a long term, excessive and/or irrelevant advertising might result in “ad blindness” where a user customarily skips over displayed advertisements. It might even result in some users not returning to a particular search engine's website, selecting instead another commercial search engine. Because commercial search engines typically supplement their activities with advertisements that provide revenue, such user activities tend to decrease the revenue that a commercial search engine provider might receive. It may also result in less revenue for an advertiser. Therefore, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which various embodiments may be practiced;

FIG. 2 shows one embodiment of a client device that may be included in a system implementing various embodiments;

FIG. 3 shows one embodiment of a network device that may be included in a system implementing various embodiments;

FIG. 4 illustrates a logical flow diagram generally showing one embodiment of an overview process for employing long and short term historical user behavior to determine a number of advertisements to be displayed and a location for which the advertisements are displayed within at least a search result page; and

FIG. 5 illustrates a non-limiting, non-exhaustive example of a search result page showing various advertisement page placement regions.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards employing long and/or short term historical user click propensity behaviors to infer a user's relative advertisement preferences, and based on such inference, adapt, or filter, a number of advertisements displayed and their location on a search results' page, called page placement for that user. A network device tracks short and long term historical click behaviors for each of a plurality of users. Then for a given search query by a tracked user, a variety of advertisements are selected as being relevant to the search query. Advertisement specific click-through rate (CTR) data is then estimated. In one embodiment, the CTR is page position normalized to minimize variations in CTR based on a position in which an advertisement is displayed within a page displayed to a user. In one embodiment, such normalized CTR may be represented by a ratio of Clicks Over Expected Clicks (COEC). A rank, ordering of the candidate advertisements may then be performed using short and/or long term user behavior data to generate a User Effective Cost Per Thousand Impressions (User effective Costs) or UeCPM. In one embodiment, the UeCPM may be determined as “COEC times a bid for a given advertisement times a user click propensity (UCP).” In one embodiment, a short term user behavior (UCPₛₜ) may be used. In another embodiment, a long term user behavior (UCPₗₜ) may be used. In still another embodiment, a combination of short and long term user behavior (UCPₛₗₜ) may be used. The advertisements may then be filtered by imposing a minimum threshold value for UeCPMs. That is, in one embodiment, advertisements having a UeCPM below the threshold might not be displayed during a search query result. Moreover, page placement for advertisements may be determined by employing a user expected revenue for an advertisement using the UCP(s) and placing those advertisements having a user expected revenue above another threshold in a particular location within the page.

As noted above, current commercial search engines typically provide organic search results in response to a user query, and then further supplements the displayed search results with advertisements that provide revenue based on, for example, a “cost-per-click,” billing model. Advertisements are typically selected from a database populated by advertisers that may bid to have their advertisement shown on a search engine result page (SERF). The search engine typically uses an estimated probability of a click on an advertisement, together with its bid in order to decide which advertisement is shown and in which order.

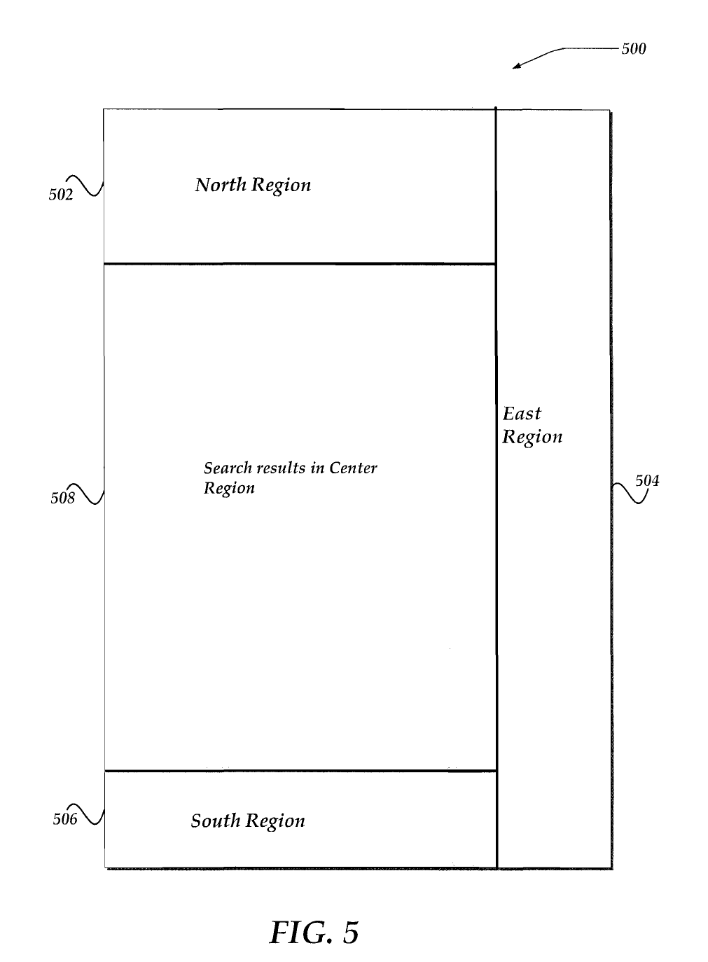

In addition to selecting and ranking candidate advertisements, a determination may also be made as to how many advertisements to show, a process called filtering, and how prominently an advertisement is to be displayed, called page placement. For example, FIG. 5 illustrates a non-limiting, non-exhaustive example of a search result page 500 showing various advertisement page placement regions, including in north region 502, above search results; in an east region 504, to a right of the search results; a south region 506, below the search results; and a central region 508, where search results are typically displayed. Typically, the real estate at the top (north region 502) is considered more valuable than other regions of the page due to highly selective user attention. Therefore, the stakes may be high, since advertisements typically receive more clicks when displayed in north region 502 over east region 504 and/or south region 506. As noted above, showing irrelevant advertisements in north region 502 may hurt a user's experience, distracting them from more relevant results. The user might subsequently lose confidence towards clicking on any advertisements, or even cease using the search engine altogether.

Therefore, the disclosure provides embodiments directed towards improving a improving a user experience by adapting to an individual's relative preferences between search query results and displayed advertisements. As discussed further below, it may be desirable to show less advertisements to be purely information-seeking, advertisement-adverse users and conversely more to shoppers. Such personalized actions then may increase user overall satisfaction, and benefit advertisers as well, as they may receive more clicks from users that are more engaged with advertisements.

Below, an operating environment is first described in which various embodiments may be practiced, which includes a client device, and a network device. Following such descriptions, the problem is further described including defining of various terminology. The approach is then described using a factor called user click propensity (UCP) to incorporate a user personalization into determining which advertisements to display and where to display them within a page.

### Illustrative Operating Environment

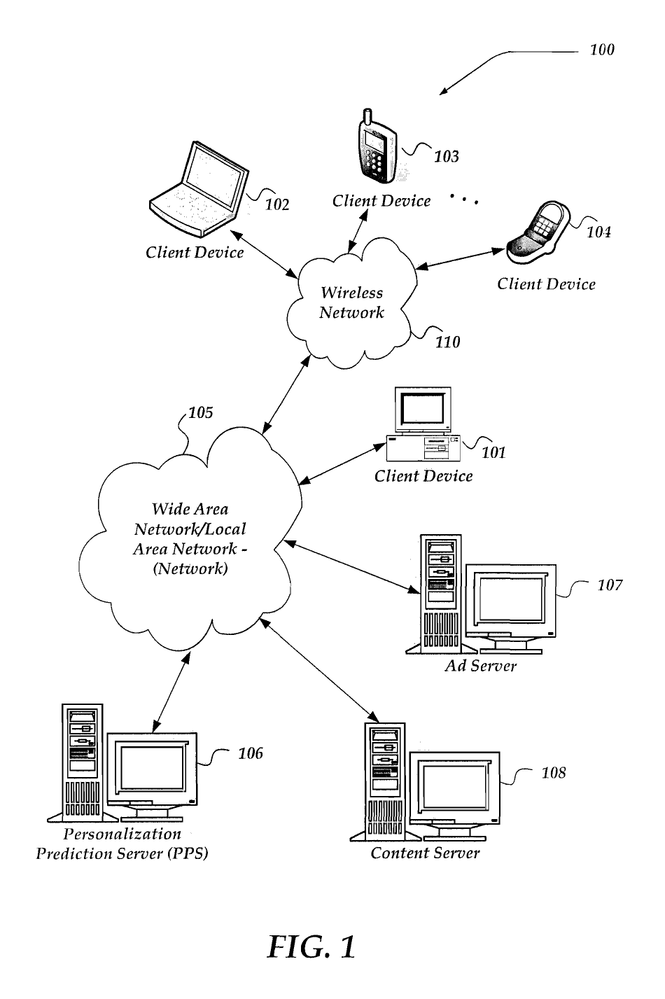

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, client devices 101-104, Personalization Prediction Server (PPS) 106, Ad server 107, and content server 108.

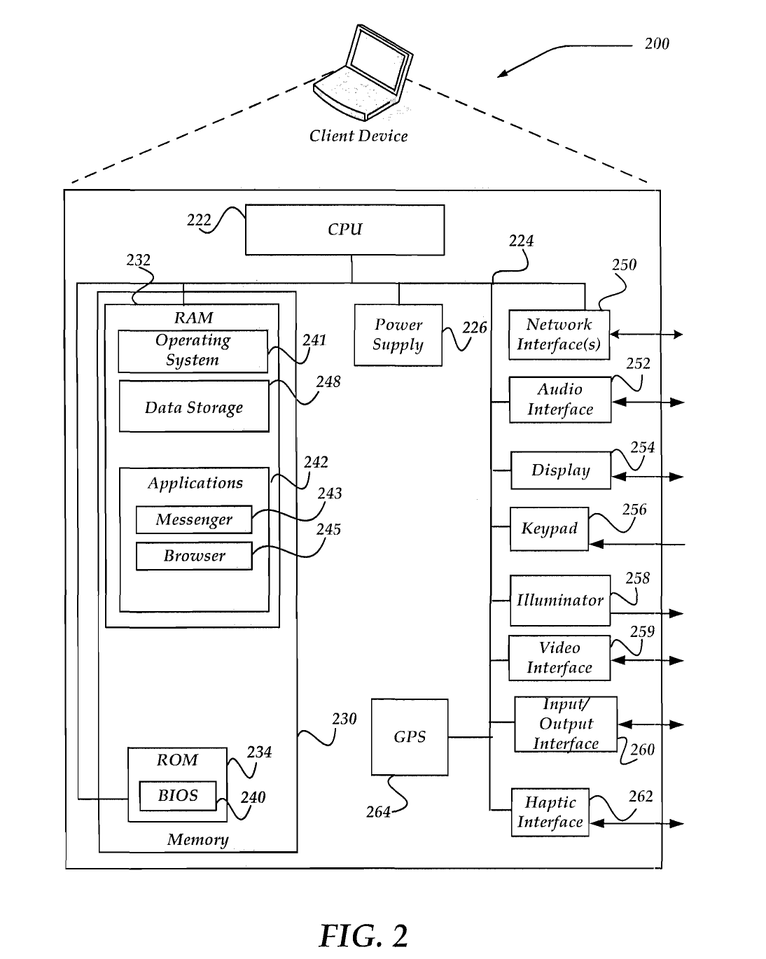

One embodiment of a client device usable as one of client devices 101-104 is described in more detail below in conjunction with FIG. 2. Generally, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, SMS, MMS, IM, IRC, mIRC, Jabber, or the like, between another computing device. However, the present invention is not limited to these message protocols, and virtually any other message protocol may be employed.

Client devices 101-104 may further be configured to include a client application that enables the user to log into a user account that may be managed by another computing device, such as content server 108, PPS 106, or the like. Such user account, for example, may be configured to enable the user to receive emails, send/receive IM messages, SMS messages, access selected web pages, or participates in any of a variety of other social networking activity. However, managing of messages or otherwise participating in other social activities may also be performed without logging into the user account. In one embodiment, the user of client devices 101-104 may also be enabled to access a web page, perform a search query for various content, or other perform any of a variety of other activities.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple PPS 106, content server 108, ad server 107, and client device 101 with other computing devices, including through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Ad server 107 includes one or more network devices that are configured to provide advertisements that may be displayed to a client device, such as client devices 101-104. In one embodiment, an advertisement may include a variety of different digital data, including, but not limited to motion pictures, movies, videos, music, audio files, text, graphics, and/or any of a combination of digital data formats. In one embodiment, Ad server 107 may store the advertisements within a computer-readable storage device residing within or accessible by Ad server 107.

Content server 108 represents one or more network devices that are configured to provide content to client devices 101-104. In one embodiment, the content may be provided to a client device based on a request for the content. However, in another embodiment, content server 108 may also provide content to a client device based on a push mechanism, wherein the content might not be requested content. Such content might include any of a variety of content that might be provided to a client device over a network, including web pages, download requests, or the like. For example, such content might also take the form of a message, such as an email message, an instant message, or the like.

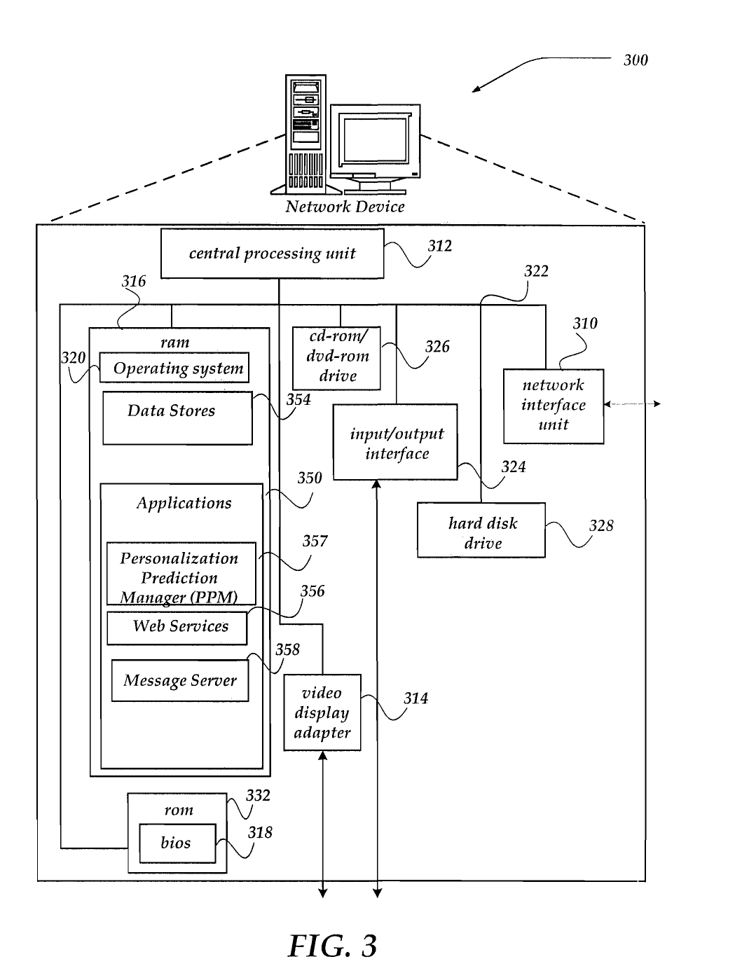

One embodiment of PPS 106 is described in more detail below in conjunction with FIG. 3. Briefly, however, PPS 106 is configured to employ long and/or short term historical user click propensity behaviors to infer a user's relative advertisement preferences, and based on such inferences, adapt, or filter a number of advertisements displayed and their location on a search results' page, or along with other content provided to a client device.

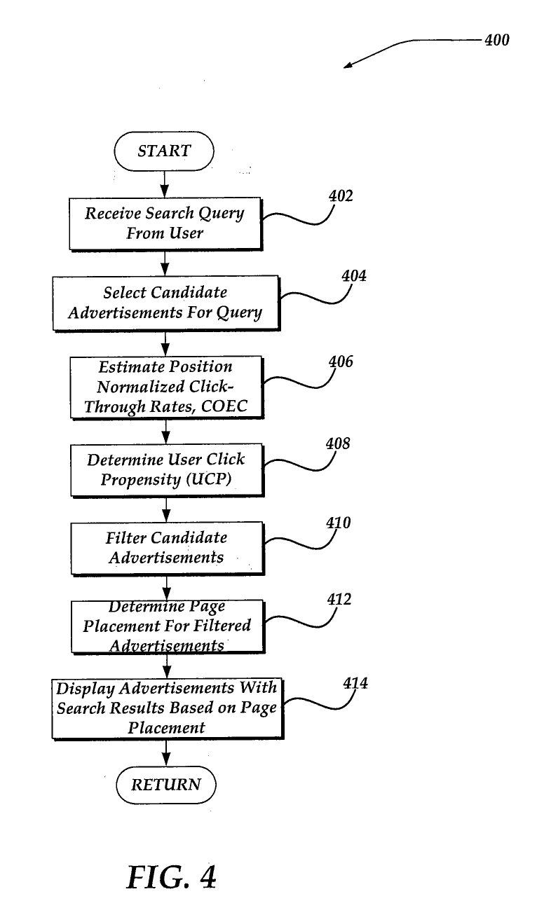

In one embodiment, PPS 106 may include a search engine that is configured to receive search queries from client devices 101-104 and to provide in response a search result page. In one embodiment, the search engine may include a various mechanisms useable to track various user activities, including, but not limited to a user's click activity for content and/or advertisements provided to the user. PPS 106 may then employ such click activity to determine one or more user's click propensities (UCPs) that may then be used to filter and place advertisements on a search result page. PPS 106 may employ a process such as described further below in conjunction with FIG. 4 to perform at least some of its actions.

Devices that may operate as ad server 107, content server 108, and/or PPS 106 include, but are not limited to personal computers, desktop computers, multiprocessor systems, microprocessor-based or programmable consumer electronics, network PCs, servers, network appliances, and the like.

Although PPS 106 is illustrated as a distinct network device, the invention is not so limited. For example, a plurality of network devices may be configured to perform the operational aspects of PPS 106. However, in another embodiment, functionality of ad server 107, content server 108, and/or PPS 106 might be performed using a single network device. Moreover, in another embodiment, ad server 107 might provide the advertisement and a user's click history to PPS 106 for analysis, while PPS 106 may also include a search query engine for use in obtaining a search query result that may be provided in conjunction with a selected advertisement. Thus, it should be recognized that while three distinct network devices are illustrated, the operations of such network devices may be combined and/or shared across virtually any arrangement. Thus, the invention is not limited to a particular arrangement of devices or distribution of functions, and other configurations are also envisaged. Therefore, system 100 should not be construed as limiting the invention.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. In addition, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage devices. Mass memory 230 illustrates another example of computer readable storage media as storage devices for storage of information such as computer readable instructions, data structures, program modules, or other data. Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, data files, graphs, videos, or the like. At least a portion of the stored information may also be stored on a disk drive or other storage medium (not shown) within client device 200.

Applications 242 may include computer executable instructions which, when executed by client device 200 within a processor such as CPU 222, may perform actions, including, transmit, receive, and/or otherwise process messages (e.g., SMS, MMS, IM, email, and/or other messages), multimedia information, and enable telecommunication with another user of another client device, as well as perform other actions associated with one or more applications, operating system components, and the like. Other examples of application programs include calendars, browsers, toolbar applications, email clients, IM applications, SMS applications, VoIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed. Moreover, browser 245 may be employed to request various content and/or receive such content, along with one or more advertisements. In one embodiment, browser 245 might also be employed to perform one or more search query requests over a network, such as the Internet, or the like, and to receive along with search results, one or more advertisements in response. In one embodiment, at least one advertisement might have been selected for inclusion based on mechanisms such as those described further below.

Messenger 243 may be configured to initiate and manage a messaging session using any of a variety of messaging communications including, but not limited to email, Short Message Service (SMS), Instant Message (IM), Multimedia Message Service (MMS), interne relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, gmail, or the like. In another embodiment, messenger 243 may be a client application that is configured to integrate and employ a variety of messaging protocols. In one embodiment, a message may also be received that includes one or more advertisements that are selected based on similar mechanisms as those described further below. For example, a content of a message may be used as a substitute to a search query. That is, an analysis of a message thread (e.g., series of multiple related messages), content of one or related messages, or the like, might be used to generate a phrase or unigram (one or more words), that may be used as though a search query was submitted. Then, rather than providing a search query result, an advertisement might be selected for insertion into one of the messages based on a process substantially similar to process 400 of FIG. 4.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, PPS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Such computer-readable media are physical devices. Computer-readable storage media may include volatile, nonvolatile, removable, and non-removable media implemented in any method or technology for storage of information, such as computer readable instructions, data structures, program modules, or other data. Examples of computer readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by a computing device.

The mass memory also stores program code and data. For example, mass memory might include data stores 354. Data stores 354 may be include virtually any mechanism usable for store and managing data, including but not limited to a file, a folder, a document, or an application, such as a database, spreadsheet, or the like. Data stores 354 may manage information that might include, but is not limited to web pages, account information, or the like, as well as scripts, applications, applets, and the like. Data stores 354 may also include advertisements; advertisement information including but not limited to user click history data, or the like. At least some of the data and other information stored within data stores 354 may be stored in part or in whole on other computer readable storage media including, hard disk drive 328, cd-rom/dvd-rom drive 326, or even on another remote network device.

One or more applications 350 may be loaded into mass memory for execution by central processing unit 312 to perform various actions. Such applications 350 may include, but are not limited to HTTP programs, customizable user interface programs, IPSec applications, encryption programs, security programs, VPN programs, web servers, account management, and so forth. Applications 350 may include web services 356, Message Server (MS) 358, and Personalization Prediction Manager (PPM) 357.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like.

Web services 356 may further include a search query engine that is configured to receive a search query request, perform a search based on the search query over a plurality of different data sources, and to provide a response to the request. In one embodiment, Web services 356 provide information about the search query request to PPM 357. Web services 356 may further receive one or more advertisements from PPM 357 for use in displaying to a client device along with a search query result. In one embodiment, Web services 356 might receive information, such as link, or the like, usable to access the one or more advertisements from other than PPM 357. For example, PPM 357 might provide a link to an advertisement residing on another network device, such as Ad server 107 of FIG. 1, or the like.

Web services 356 may further include a component that is configured to monitor various click-through selections of displayed advertisements, and other user activities. In one embodiment, for example, web services 356 might detect a user's activities and store such activities within one or more web search logs, or the like, that may be stored in data stores 354. In one embodiment, web services 356 might employ such information to estimate a user's ad click rates. In one embodiment, web services 356 might track searches as well as click activity. A search, for example, might be followed by zero or more click selections on various SERP links displayed to the user's client device, on organic search results, and/or advertisements. In one embodiment, web services 356 are configured to distinguish and thereby track click activities for advertisements distinct from other user click activities. In one embodiment, web services 356 may associate corresponding searches and clicks by a given user through a unique search identifier. Further, web searches 356 might include for each record associated with a tracked activity, a timestamp, browser cookie, and an associated search query. In one embodiment, a browser cookie may be equated to a given user/client device, however, other identifiers, such as those disclosed above may also be used. A set of searches and clicks issued by a browser cookie (or other identifier), within a given time period is referred to as a user's history. In general, when using data from web searches, web services 356 may be further configured to distinguish and thereby filter out activities detected as spam and/or robot traffic. Web services 356 may employ any of a variety of mechanisms to detect and filter out such ‘non-user’ activities.

Message server 358 may include virtually any computing component or components configured and arranged to forward messages from message user agents, and/or other message servers, or to deliver messages to a local message store, such as data stores 354, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like. In one embodiment, information from one or more messages might be provided to PPM 357 for use in selecting an advertisement for insertion into at least one message.

It should be noted, however, that message server 358 is not constrained to email messages, and other messaging protocols may be managed by one or more components of message server 358. Thus, message server 358 may also be configured to manage SMS messages, IM, MMS, IRC, mIRC, or any of a variety of other message types.

PPM 357 is configured to receive information from web services 358 regarding a user's long and term historical click propensity behaviors. PPM 357 may examine the information and separate the information into short term behaviors and long term behaviors. PPM 357 may employ virtually any time period to distinguish long term from short term behaviors. For example, in one embodiment, PPM 357 may define short term behaviors to be those behaviors detected with a twenty-four hour period that immediately precedes current time, while long term behavior may be within an immediate last 28 days. However, other periods may also be selected.

PPM 357 may then employ such information determine a user's short term click propensity represented by UCPₛₜ and the user's long term click propensity represented by UCPₗₜ. In one embodiment, PPM 357 might further determine a user's click propensity that represents a combination of short and long term click propensity, represented by UCPₛₗₜ.

PPM 357 may further receive information from web services 356 indicating that the user has submitted a web search query. PPM 357 may provide the search query to another network device, another component, or the like, and in response, receive a selection of candidate advertisements for possible display with a result of the web search query. In one embodiment, web services 357 may provide the selection of candidate advertisements to PPM 357. In any event, PPM 357 may then estimate an ad-specific click-through rate (CTR) for each candidate advertisement. However, in another embodiment, such estimates may be received by PPM 357 from another network device, or component. While CTR may be used, other embodiments, may consider machine-learned click predictions that further consider a variety of additional features, including for example, syntactic and/or semantic similarity between a query and an advertisement, advertisement snippet, or the like.

In one embodiment, as a display position of an advertisement may have a dominant influence on a CTR, regardless of an advertisement quality, PPM 357 may position normalize the received CTR. In one embodiment, PPM 357 may obtain such position normalized measure by determining a click over expected clicks (COEC); where a position bias is captured in terms of a reference CTR, c̅t̅r̅ᵢ, as the mean click-through rate at a given page position i (averaging over all advertisements that have been shown at position i); the advertisement-specific click may be computed by dividing a total number of obtained clicks by a sum of expected clicks (according to a reference CTR) for a position in which an advertisement is shown.

PPM 357 may then rank, order the candidate advertisements using short and/or long term UCPs to generate a User Effective Cost Per Thousand Impressions (UeCPM) or “user expected cost” for an advertisement. In one embodiment, the UeCPM may be determined as “COEC times a bid for a given advertisement times a user click propensity (UCP).” In one embodiment, PPM 357 may then filter the candidate advertisements by imposing a minimum threshold value for UeCPMs. That is, in one embodiment, advertisements having a UeCPM below the threshold might not be displayed during a search query result. PPM 357 may then determine page placement for the remaining advertisements by using the UCP(s) to estimate a user expected revenue for an advertisement, and placing those advertisements having a user expected revenue above another threshold in a particular location within the page. PPM 357 may employ a process such as described further below in conjunction with FIG. 4 to perform at least some of its actions.

### Generalized Operation

The operation of certain aspects of the invention will now be described with respect to FIG. 4. FIG. 4 illustrates a logical flow diagram generally showing one embodiment of an overview process for employing long and/or short term historical user behavior to determine a number of advertisements to be displayed and a location for which the advertisements are displayed within at least a search result page.

Process 400 of FIG. 4 begins, after a start block, at block 402, where a user's search query is received. Processing continues next to block 404, where candidate advertisements are selected that are determined to be relevant to the received search query. In one embodiment, the candidate advertisements may be retrieved from a database where bid terms are determined to be identical (e.g., an exact match) to the query, or are determined to be related according to various rewriting criteria (e.g., an advanced match).

Processing then flows to block 406, where an estimated advertisement click-through rate is determined that is position normalized, as discussed above. That is, in one embodiment, the clicks over expected clicks, COEC may be determined.

Continuing next, user click history data is employed to determine one or more UCPs. In one embodiment, a historical click propensity factor may be determined as follows for a given time period (short term or long term). For the given user, based on their cookie, or other identifier, the user's behavior is received for up to a maximum of the relevant time period. For each viewed page, a total predicted number of clicks on any advertisement may be computed as:

$$p ( click ) = {\sum }_{i = 1}^{N} \overline{{ctr}_{i}} * {coec}_{i}$$

where there are N advertisements shown at positions 1, . . . , N, and coecᵢ is a prediction of the baseline, non-personalized click mode for the i-th advertisement. By dividing the actually obtained clicks within the time period of interest by the sum of these predictions, an average click propensity is obtained for the user. To distinguish this ratio for the concept of COEC, which refers to page position normalization described above, the ratio may be referred to as clicks over predicted clicks or COPC. In order to avoid large deviations in cases of sparse data, in one embodiment, UCP may be smoothed using the following:

$$U C P = \frac{{\sum }_{i} {click}_{i} + {click}_{0}}{{\sum }_{i} {p ( click )}_{i} + {click}_{0}} \qquad ( 1 )$$

where i runs over all search events for the user during the relevant time period, and clickᵢ and p(click)ᵢ are the observed and predicted clicks for search p, respectively. Click₀ represents a constant corresponding to a weight of a prior, with a prior COPC of one. In one embodiment, click₀ may range from between about 0.5 to about 1.0; however, other values may also be used. As such, however, a new user without history, or one with very little history, would have a UCP at or near one.

Equation (1) may be employed to determine UCPₛₜ or UCPₗₜ by varying from which time period the user behavior data is selected. Such UCPₛₜ may be recognized as complementary, in that UCPₗₜ is directed towards capturing the fact that some users tend to pay more attention to advertisements in general, while others customarily skip to the web results right away. On the other hand, while someone is shopping for a product/service, or the like, they might click on a number of advertisements; but once the user actually selects, purchases, or ceases to search for the product/service for any of a variety of reasons, their click rate on advertisements typically drops back to their lower long-term average. Thus, UCPₛₜ seeks to account for the user's short term behavior changes. However, in another embodiment, there may be a benefit in combining these two user propensity factors into a single value. Thus, in one embodiment, a combination of UCPₛₜ and UCPₗₜ, or UCPₛₗₜ, may also be determined, as:

$$U C {P}_{slt} = [ {α}_{1} {\sum }_{i ∈ S} {click}_{i} + {α}_{0} {ucp}_{lt} ] / [ {\sum }_{i ∈ S} {p ( click )}_{i} + {α}_{2} ]$$

where S is the set of searches in the short-term, and α₀, α₁, and α₂ may be determined by minimizing a loss function similar to:

L=SUMᵢ(p(click)ᵢ*UCPₛₗₜ−clickᵢ)²

Processing continues to block 410. where the candidate advertisements may be rank ordered and filtered. In one embodiment, the candidate advertisements may be rank ordered by coec*bid, called eCPM. This cost per click may be determined as a minimum amount an advertiser would have to bid to maintain their rank; thus resulting in a cost of eCPMᵢ₊₁/coecᵢ for the advertisement at rank i, or a minimum reserve price in case of a last advertisement. Such determinations fail to account for a user's click propensity. However, the rank-normalized estimates of CTR for an ad i can be refined using the above disclosed UCP(s).

It is recognized that UCP, per se may not affect a ranking or pricing, since all scores are scaled proportionally, however, use of the UCP is directed towards providing a personalization of the number of advertisements that may be shown to a user as well as the placement of these advertisements. Thus, for filtering, the following is used:

coec*UCP*bid>UeCPMₘᵢₙ.

where the left side of the above equation may be referred to as a user effective cost or UeCPM, determined for each advertisement for a given user. That is, if a given candidate advertisement's determined cost based on the above exceeds the minimum threshold value, then the candidate advertisement is retained for possible display. It is expected that by imposing such minimum threshold, less cluttered results pages may be displayed to a user, thereby improving the user's experience.

Continuing to block 412, for those candidate advertisements remaining, a north region placement may be determined. At block 412, a determination may be made as to how many of the remaining advertisements may be shown in a north region of a page. In one embodiment, a user expected revenue may be estimated from an advertisement at rank i, under the assumption that it is placed in the north region. In one embodiment, a user expected revenue may be determined as:

c̅t̅r̅ᵢ̅*coecᵢ*ucp*bidᵢ

Assuming a fixed, global threshold of θₙₒᵣₜₕ, then starting with a top-ranked remaining advertisement, a comparison is performed of the user expected revenue with the global threshold θₙₒᵣₜₕ. If the user expected revenue is greater that the global threshold, then the advertisement may be allocated to a north region based on its ranking among the remaining advertisements. This evaluation may be continued with the remaining advertisements until either an advertisement doesn't quality, or a maximum number of available display slots have been filled for the north region. Virtually any number of available display slots may be allocated, however, it is preferred that the number not be so large as to overwhelm a display of the search results. Thus, typical values for the number of available display slots may range between 2-6. However, other values may also be used. In one embodiment, if there are remaining advertisements that are not placed into the north region, then they may be placed in the east region, until a maximum number of available display slots for the east region have been allocated. In one embodiment, such maximum number is typically larger than the number allocated in the north region. Thus, such values may range from 3-10, however, other values may also be used. In one embodiment, should more advertisements still remain, they may either be discarded or allocated to a south region of the page. In one embodiment, an east threshold may also be used to limit a number of advertisements allocated to the east region. Tuning of the global threshold of θₙₒᵣₜₕ and/or an east threshold provides a balance between revenue and a user perception, and may therefore be based on a business decision.

Processing then flows to block 414, where the allocated advertisement may be provided to the user's client device, along with the search results. Process 400 may then return to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

### Machine-Learned Personalization Model

While the above generates an overall average click propensity, it may not employ available information about an exact timing within a history window of a user's click activity, nor of a relationship between previous queries and a current query for the user. That is, if a user issues a query that is similar to one issued before and on which the user clicked an advertisement, it might be expected that the user is more likely to click on the current page, as well.

Thus, to exploit this relationship, another prediction model may be trained with cookie specific session features based on view and click events within a last time period, such as 24 hours, or the like. A query similarity may be captures using a number of syntactic overlap features. Let q* denote a current query, and qᵢ an earlier query. Then, can count a number of common words, |q*∩qᵢ|; the word cosine distance being defined as:

w cos(q*,qᵢ)=[|q*∩qᵢ|]/sqrt(|q*|*|qᵢ|)

and a word overlap may be determined as:

w_overlap(q*,qᵢ)=[|q*∩qᵢ|]/|q*|

Further, wpref cos and wpref_overlap are defined as measures analogously by counting common prefix word, such as maximum common words that occur in both queries in the same order, starting at the first word. Additionally, features that count characters instead of words may also be added.

These measures may be applied to a most recent query, the most recent clicked query, and/or the most recent non-clicked query (if existing). Moreover, weighted click propensity factors may be formed over all (clicked, non-clicked) previous queries in a history. For example, the following may be defined:

$$wcos\_copc = [ {\sum }_{i} {click}_{i} * w cos ( {q}^{*} , {q}_{i} ) ] / [ {\sum }_{i} {p ( click )}_{i} * w cos ( {q}^{*} , {q}_{i} ) ]$$

This may be considered as analogous to the overall click propensity factor described above, but is directed at providing a proportionally higher weight to more similar queries.

Other features may also be included. Such as UCPₗₜ, UCPₛₜ, average and current word and query lengths; total number of searches and clicks in a history; a number of searches, clicks, total p(click) and/or coec for repeat queries; elapsed time since a last search and click; or the like. In one embodiment, a query session click clickability or QSCB may be determined. That is a hash table of relative click propensities may be computed offline over a period of time, such as a month. The table may then indexed by a current query, the total p(click), and clicks in a preceding 24-hour window. To cope with data sparsity, the latter two may be quantized into roughly equivalent bins.

Machine-learned models are trained to predict UCP such that a loss function similar to the following is minimized:

L=SUM(p(click)ᵢ*gamma−clickᵢ)

Where gamma is the model prediction. In one embodiment, a Stochastic Gradient-Boosted Decision Tree model was trained. Other machine-learning and/or other prediction models may also be used.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems that perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over the network; and
a processor that is operative to perform actions, including:
receiving a request from a user for a search query;
determining a plurality of candidate advertisements based on the search query;
estimating for each candidate advertisement a click-through rate;
determining for the user at least a user click propensity (UCP) based on a defined time period of tracked user behaviors;
determining a user effective cost (UeCPM) for each advertisement based on the click-through rate, the UCP, and an associated bid for the respective candidate advertisement from an advertiser;
determining a user expected revenue for each candidate advertisement based in part on the UCP; and
selectively displaying at least one of the candidate advertisements based on a candidate advertisement's UeCPM, and further selecting a location within a display page to the user based on the candidate advertisement's user expected revenue.

2. The network device of claim 1, wherein the user click propensity (UCP) employs a combination of long-term user behavior and short-term user behavior to determine a combined short term/long term UCP.

3. The network device of claim 1, wherein the click-through rate is further page position normalized using a clicks over expected clicks (coec) computation for each candidate advertisement.

4. The network device of claim 1, wherein selectively displaying at least one of the candidate advertisements further comprises:
comparing each candidate advertisement's determined UeCPM to a minimum threshold value;
if a given candidate advertisement's determined UeCPM exceeds the minimum threshold, allowing the given candidate advertisement to be displayed to the user, and
if a given candidate advertisement's determined UeCPM is less than the minimum threshold, inhibiting the given candidate advertisement from being displayed to the user.

5. The network device of claim 4, wherein selecting a location further comprising:
for a defined number of slots within a north region of the display page:
for each candidate advertisement to be displayed to the user, allowing the candidate advertisement to be displayed within the north region if the candidate advertisement's user expected revenue exceeds another threshold; otherwise, allowing the candidate advertisement to be displayed within one of an east region or south region of the display page until a east number of slots and a south number of slots are filled.

6. The network device of claim 1, wherein the UCP is smoothed using a smoothing factor.

7. The network device of claim 1, wherein the UCP is determined in part using a machine-learning prediction model using tracked user behavior over at least the defined time period.

8. A computer-readable storage device having computer-executable instructions stored thereon, the computer-executable instructions when installed onto a computing device enable the computing device to perform actions, comprising:
receiving a request from a user for a search query;
determining a plurality of candidate advertisements based on the search query;
estimating for each candidate advertisement a page position normalized click rate as clicks over expected clicks (coec);
determining for the user at least one user click propensity (UCP) based on a defined time period of tracked user click behaviors;
determining a user effective cost (UeCPM) for each candidate advertisement based on the coec, the at least one UCP, and an associated bid for the respective candidate advertisement from an advertiser;
determining a user expected revenue for each candidate advertisement based in part on the at least one UCP and coec; and
in response to the search query request, selectively displaying the candidate advertisements within a search result page based on the candidate advertisement's UeCPM, and further selecting a location within the search result page based on the candidate advertisement's user expected revenue.

9. The computer-readable storage medium of claim 8, wherein the at least one UCP is determined from one of short term user click behaviors, or long term user click behaviors, wherein short term and long term are over defined time periods.

10. The computer-readable storage medium of claim 8, wherein the UCP is determined based on tracked user click behaviors that are further analyzed based on query similarities over the defined time period.

11. The computer-readable storage medium of claim 8, wherein the at least one UCP is determined using a stochastic gradient-descent boosted tree model.

12. The computer-readable storage medium of claim 8, wherein selectively displaying at least one of the candidate advertisements further comprising:
comparing each candidate advertisement's determined UeCPM to a minimum threshold value;
if a given candidate advertisement's determined UeCPM exceeds the minimum threshold, allowing the given candidate advertisement to be displayed to the user, and
if a given candidate advertisement's determined UeCPM is less than the minimum threshold, inhibiting the given candidate advertisement from being displayed to the user.

13. The computer-readable storage medium of claim 8, wherein selecting a location further comprising:
for a defined number of slots within a north region of the display page:
for each candidate advertisement to be displayed to the user, allowing the candidate advertisement to be displayed within the north region if the candidate advertisement's user expected revenue exceeds another threshold; otherwise, allowing the candidate advertisement to be displayed within one of an east region or south region of the display page until a east number of slots and a south number of slots are filled.

14. The computer-readable storage medium of claim 8, wherein the at least one UCP is determined from a sum of clicks for each candidate advertisement divided by a sum of predicted clicks over each search event for the user within the defined time period.

15. A system, comprising:
a computer-readable storage device having stored thereon a plurality of advertisements; and
a network device having a processor that executes instructions that perform actions, including:
receiving a request from a user for a search query;
receiving a plurality of candidate advertisements from the stored plurality of advertisements based on the search query;
estimating for each candidate advertisement a page position normalized click rate as clicks over expected clicks (coec);
determining for the user a user click propensity (UCP) based on a defined time period of tracked user click behaviors;
determining a user effective cost (UeCPM) for each candidate advertisement based on the coec, the UCP, and an associated bid for the respective candidate advertisement from an advertiser;
determining a user expected revenue for each candidate advertisement based in part on the UCP and coec; and
in response to the search query request, selectively displaying the candidate advertisements within a search result page based on the candidate advertisement's UeCPM, and further selecting a location within the search result page based on the candidate advertisement's user expected revenue.

16. The system of claim 15, wherein the UCP is determined using a stochastic gradient-descent boosted tree model.

17. The system of claim 15, wherein selectively displaying at least one of the candidate advertisements further comprising:
comparing each candidate advertisement's determined UeCPM to a minimum threshold value;
if a given candidate advertisement's determined UeCPM exceeds the minimum threshold, allowing the given candidate advertisement to be displayed to the user, and
if a given candidate advertisement's determined UeCPM is less than the minimum threshold, inhibiting the given candidate advertisement from being displayed to the user.

18. The system of claim 17, wherein selecting a location further comprising:
for a defined number of slots within a north region of the display page:
for each candidate advertisement to be displayed to the user, allowing the candidate advertisement to be displayed within the north region if the candidate advertisement's user expected revenue exceeds another threshold; otherwise, allowing the candidate advertisement to be displayed within one of an east region or south region of the display page until a east number of slots and a south number of slots are filled.

19. The system of claim 15, wherein the UCP is determined based on tracked user click behaviors that are further analyzed based on query similarities over the defined time period.

20. The system of claim 15, wherein the UCP is determined by a combination of short term user click propensity and long term user click propensity, wherein short term and long term are over defined time periods.
